(19) United States
(12) Patent Application Publication
(10) Pub. No.: US 2015/0014235 A1
(43) Pub. Date: Jan. 15, 2015

(54) SYSTEMS AND METHODS FOR PROVIDING A FEEDWELL

(71) Applicants: Michael Empey, Sandy, UT (US); Glenn Welch, Bountiful, UT (US)

(72) Inventors: Michael Empey, Sandy, UT (US); Glenn Welch, Bountiful, UT (US)

(21) Appl. No.: 14/331,120

(22) Filed: Jul. 14, 2014

Related U.S. Application Data
(60) Provisional application No. 61/845,947, filed on Jul. 12, 2013.

(51) Int. Cl. C02F 1/52; B01F 15/02; B01D 43/00

(52) U.S. Cl. CPC C02F 1/5281; B01D 43/00; B01F 15/0201; B01F 2215/0052; C02F 2301/04
USPC 210/205; 210/198.1

(57) ABSTRACT

Feedwell devices are described herein. While the described feedwells can include any suitable component, in some cases, the feedwell has a center portion, a launder, a weir, and/or a mixing zone. While the various components can have any suitable relationship with respect to each other, in some cases, the weir surrounds a portion of the feedwell's center portion and is configured to allow supernatant from a thickener (e.g., a thickener in which the feedwell device has been placed) to flow into the launder. In turn, in some implementations, the launder is configured to direct the supernatant to the mixing zone. Additionally, in some implementations, the mixing zone is configured to mix the supernatant with a feed slurry, prior to introducing a mixture of the supernatant and the feed slurry into the center portion of the feedwell. Other implementations are described.

### RELATED APPLICATION

This application claims priority to U.S. Provisional Patent Application Ser. No. 61/845,947, filed Jul. 12, 2013, and entitled “SYSTEMS AND METHODS FOR PROVIDING A FEEDWELL” (Attorney Docket No. 19661.4); the entire disclosure of which is hereby incorporated herein by reference.

### BACKGROUND OF THE INVENTION

1. Field of the Invention

The present invention relates to the thickening and clarifying industry. In particular, some implementations of the present invention relate to systems and methods for providing a feedwell device that mixes feed slurry, dilution water (or thickener supernatant), and one or more flocculants prior to the time when such a mixture is introduced into the feedwell.

2. Background and Related Art

In the thickening and clarifying industry, feedwells and thickeners are well known.

In this regard, in many conventional thickeners, a feedwell is disposed within the thickener, such that the feedwell is configured to receive a feed solution that is fed from the feedwell into the thickener, where solids are allowed to settle to the bottom of the thickener. In some cases, the solids that settle at the bottom of the thickener, are scraped from the bottom of the thickener and removed.

While many conventional feedwells and thickeners have been found to be useful for removing solids from water, such feedwells and thickeners are not necessarily without their shortcomings. Accordingly, it would be an improvement in the art to augment or even replace current techniques with other techniques.

### SUMMARY OF THE INVENTION

The present invention relates to the thickening and clarifying industry. In particular, some implementations of the present invention relate to systems and methods for providing a feedwell device that mixes feed slurry, dilution water (or thickener supernatant), and one or more flocculants prior to the time when such a mixture is introduced into the feedwell.

While the described feedwell device can comprise any suitable component, in some non-limiting implementations, the feedwell device comprises a feedwell having a center portion, a launder disposed around a portion of the feedwell, a weir disposed around a portion of the launder, and/or a mixing zone. In this regard, the various components can have any suitable relationship with respect to each other. Indeed, in some implantations, the weir is configured to allow supernatant from a thickener (e.g., a thickener in which the feedwell device has been placed) to flow into the launder. In turn, in some implementations, the launder is configured to direct the supernatant to the mixing zone. Additionally, in some implementations, the mixing zone is configured to mix the supernatant with a feed slurry, prior to introducing a mixture of the supernatant and the feed slurry into the center portion of the feedwell.

### BRIEF DESCRIPTION OF THE DRAWINGS

In order that the manner in the above recited and other features and advantages of the present invention are obtained, a more particular description of the invention will be rendered by reference to specific embodiments thereof, which are illustrated in the appended drawings. Understanding that the drawings depict only typical embodiments of the present invention are not, therefor, to be considered as limiting the scope of the invention, the present invention will be described and explained with additional specificity and detail through the use of the accompanying drawings in which:

FIG. 1 illustrates a perspective view a feedwell device in accordance with a representative embodiment of the invention;

FIG. 2 illustrates a flow chart of a representative embodiment of a method for using the feedwell;

FIG. 3 illustrates a perspective view of a portion of the feedwell, illustrating a mixing zone and a flocculation zone in accordance with a representative embodiment;

FIGS. 4 and 5 each illustrate a top plan view of a portion of a representative embodiment of the feedwell;

FIG. 6 illustrates a side schematic view of a portion of a representative embodiment of the feedwell comprising a pump;

FIG. 7A illustrates a partial cutaway view of a portion of a representative embodiment of the feedwell;

FIGS. 7B-7C respectively illustrate a representative method for removing and installing a representative embodiment of a pump into a representative embodiment of the feedwell;

FIG. 8A illustrates a top schematic view of a representative embodiment of the feedwell;

FIG. 8B illustrates a perspective view of a representative embodiment of the feedwell;

FIG. 8C illustrates a side schematic view of a representative embodiment of the feedwell;

FIGS. 9-10 and 13-19 illustrates different views of representative embodiments of the feedwell, showing the distribution of a solid's concentration during operation of the feedwell in accordance with some embodiments of the invention; and

FIGS. 11-12 depict a fluid head differential created by a pump in some embodiments of the described invention.

### DETAILED DESCRIPTION OF THE INVENTION

The present invention relates to systems and methods that may be used in the thickening and clarifying industry. In particular, the present invention relates to systems and methods for providing a feedwell device that mixes feed slurry, dilution water, and flocculant prior to the time when such mixture is introduced into the feedwell.

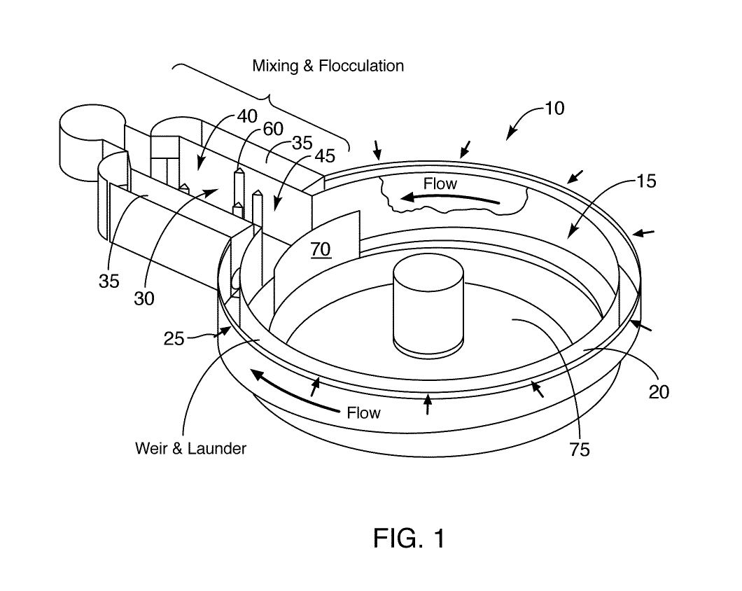

While the described feedwell device can comprise any suitable component, FIG. 1 shows some embodiments it which the feedwell device 10 comprises a feedwell 15, a launder 20, a weir 25, and/or a mixing and flocculation zone (collectively shown at 30) that is at least partially disposed outside of the feedwell 15.

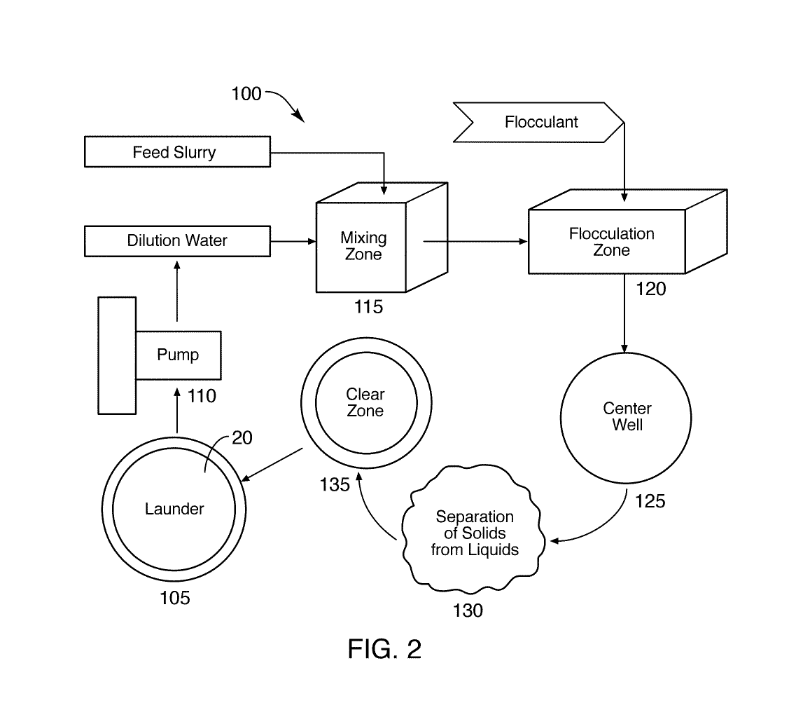

Although the feedwell device 10 can function in any suitable manner, in some embodiments, the feedwell 15 is placed in a fluid-filled thickener (not shown). FIG. 2 (at 105) shows that, in some embodiments, fluid (e.g., clear liquid) from the thickener is then allowed to flow over the weir 25 and into the launder 20.

With regard to the weir 25, the weir can have any suitable characteristic, including, without limitation, one or more notches (e.g., V-shaped, U-shaped, square shaped, and/or other shaped notches), holes, openings, grooves, etc. that: promote a substantially even draw of supernatant from the thickener for use as feed dilution, minimize rise rates around the launder by maximizing weir length, and/or eliminate (and/or reduce) draw points.

While the launder 20 can have any suitable characteristic, in some embodiments, it comprises a circumferential launder that extends around all or a portion of the feedwell 15.

Additionally, in some non-limiting embodiments, the launder is raised at one end and slopes towards, so as to channel or otherwise direct fluid to, one or more conduits 35 that are configured to feed into the mixing zone 40.

In some embodiments, one or more pumps (as shown at 110 in FIG. 2) are configured to force such fluid from the launder 20 into the mixing zone 40 to mix with feed slurry at a desired speed, concentration, and/or pressure. While the pump can comprise any suitable pumping mechanism, in some embodiments, it comprises a relatively low head/high volume pump (e.g., a pump that is configured to provide between about 0.5 and about 13 feet of head or any sub-range thereof, such as between about 1 and about 6 feed of head) that allows for a forced and regulated flow of the dilution water.

At 115, FIG. 2 shows that, in some embodiments, feed slurry and dilution water (e.g., from the launder 20) are mixed in the mixing zone 40. While the mixing zone can have any suitable component or characteristic that allows it to properly mix feed slurry with dilution water, in some embodiments, it comprises one or more static mixers 60 (or any other stationary and/or semi-stationary mixers) that help the mixing zone mix the fluids. In some such embodiments, the mixing zone is further configured to utilize the energy generated from the flow of the dilution stream to mix the fluids against the static mixers.

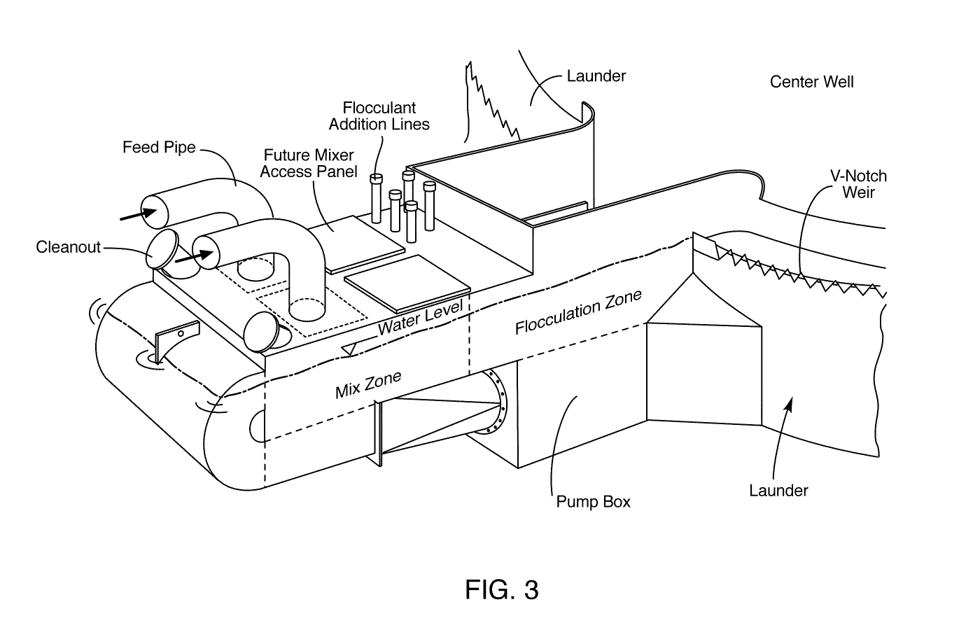

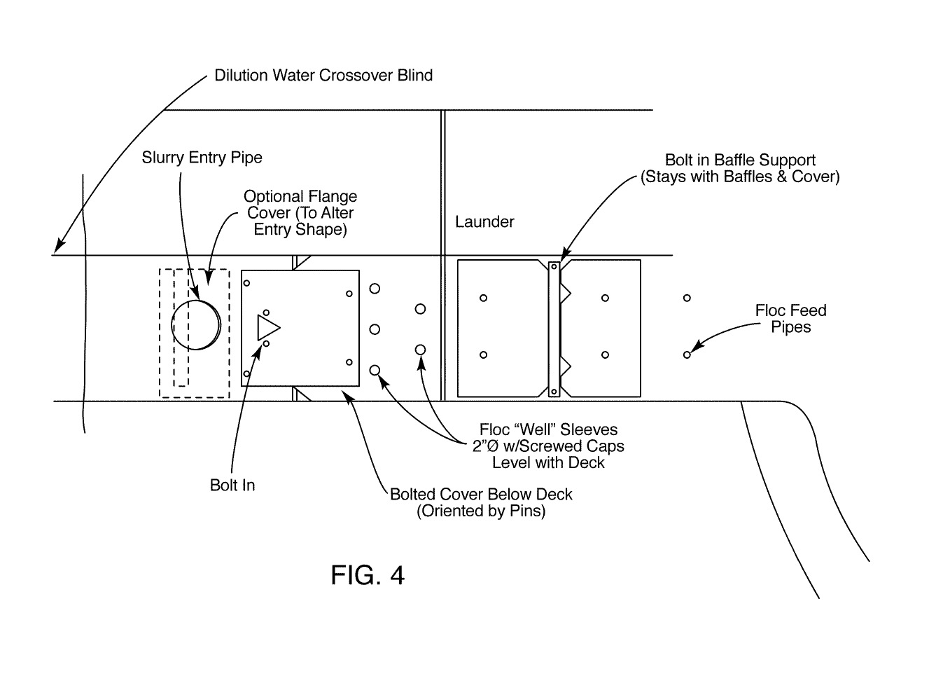

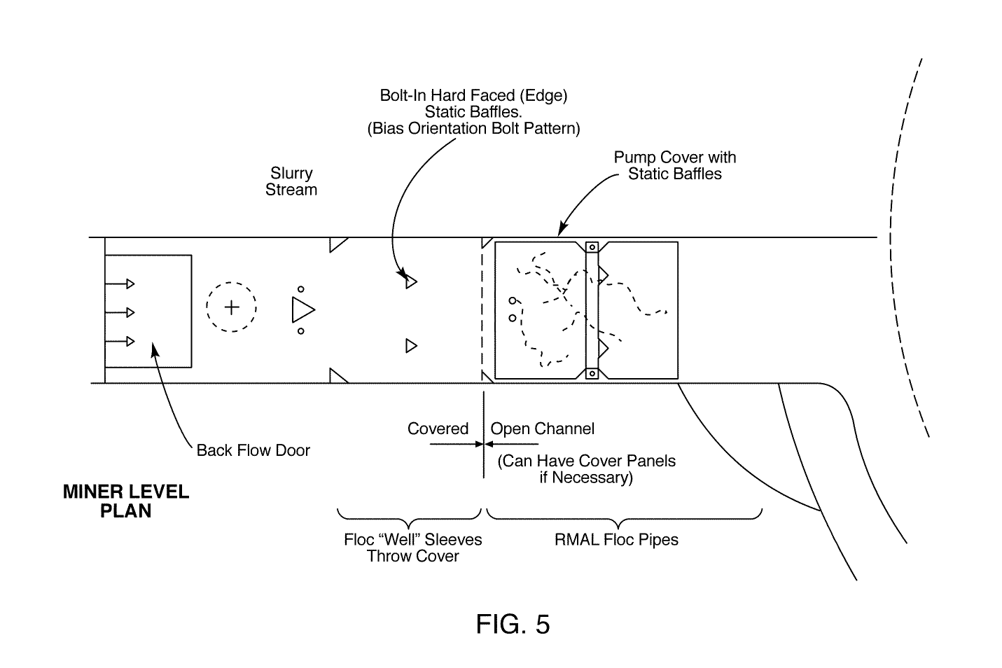

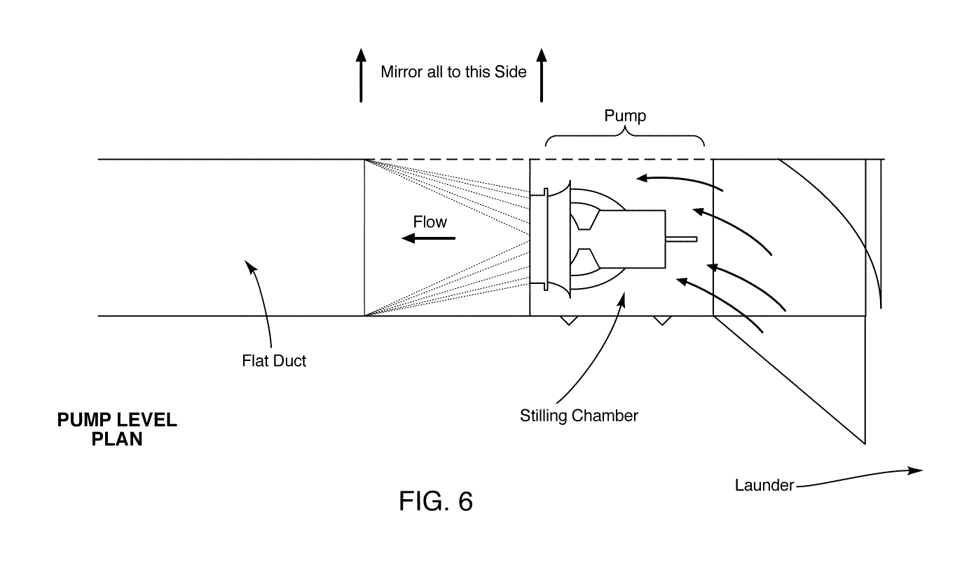

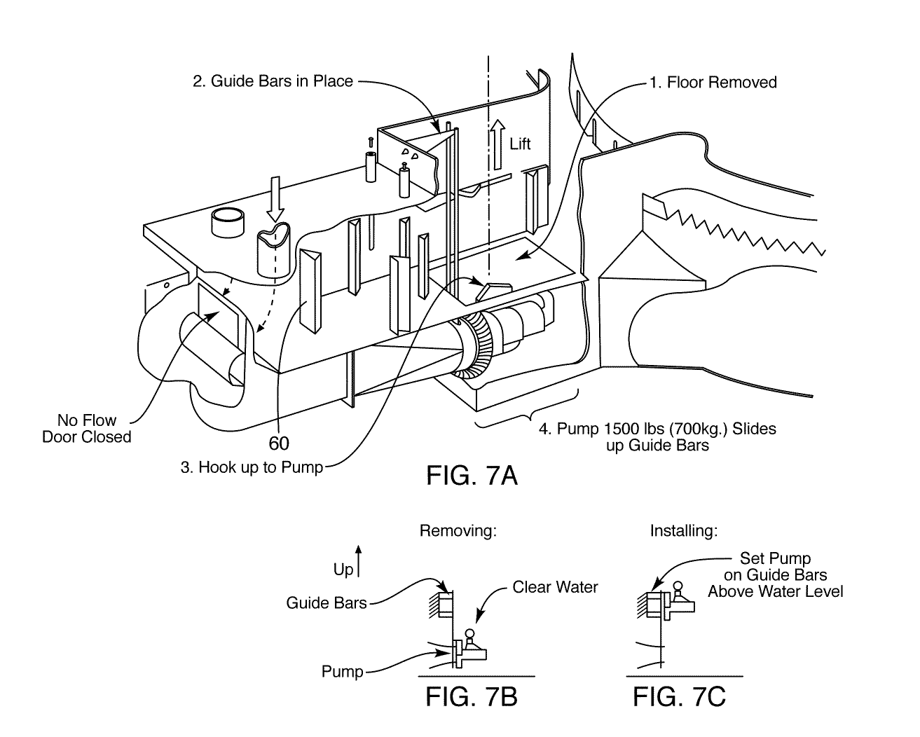

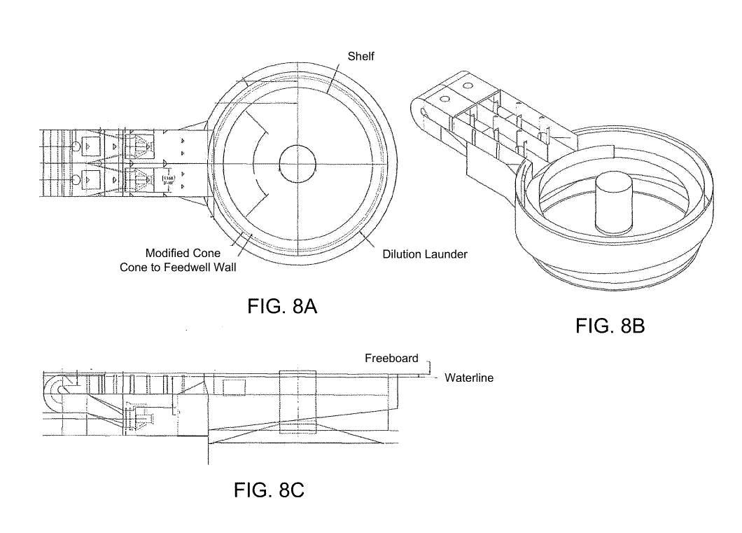

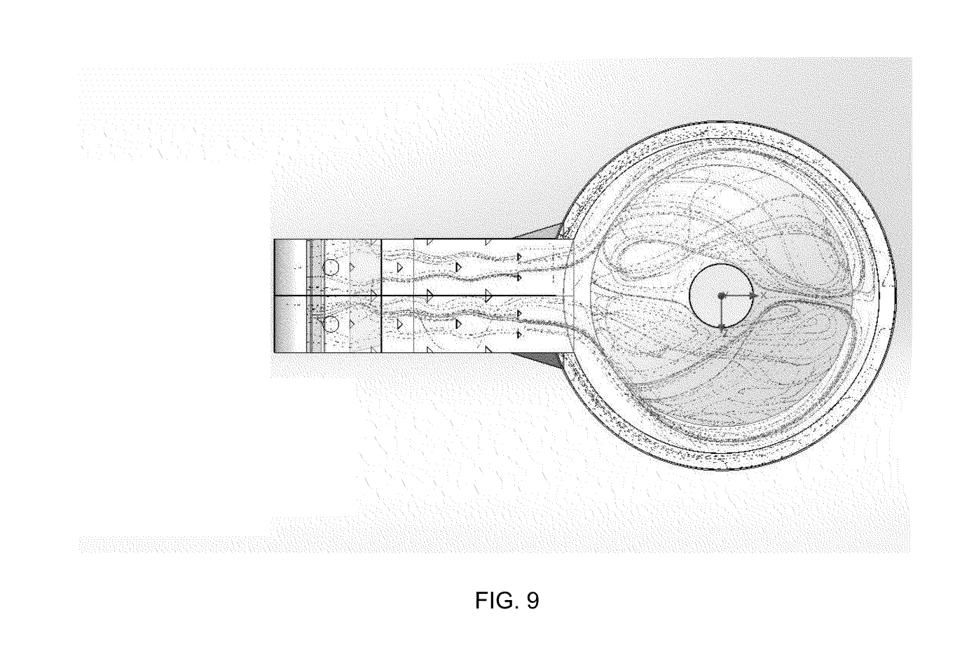

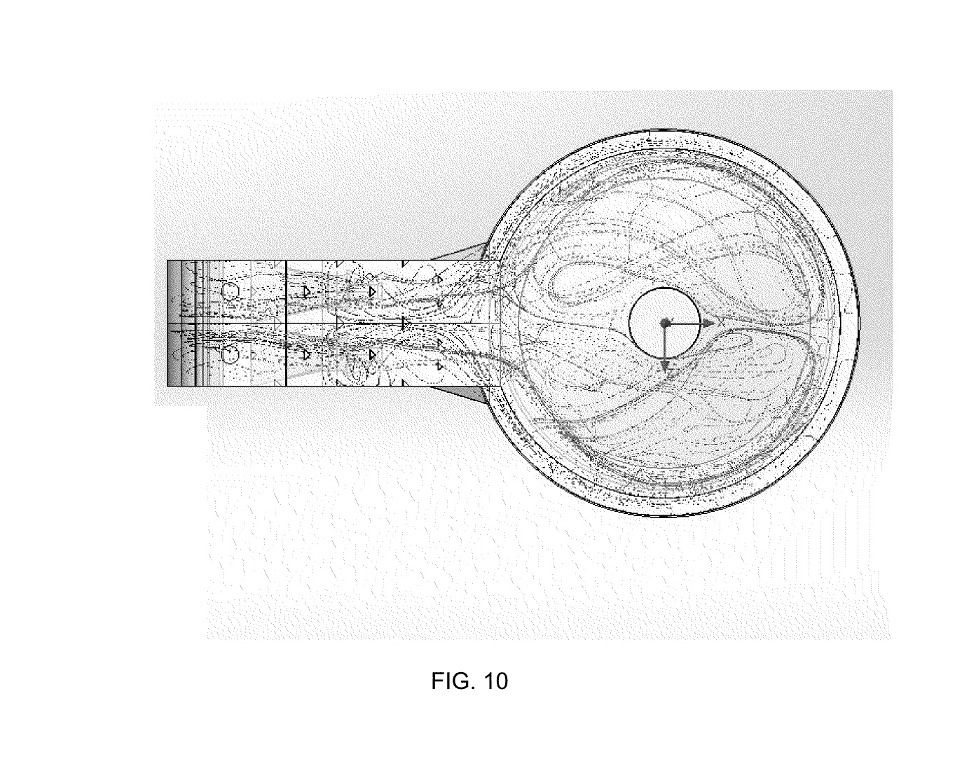

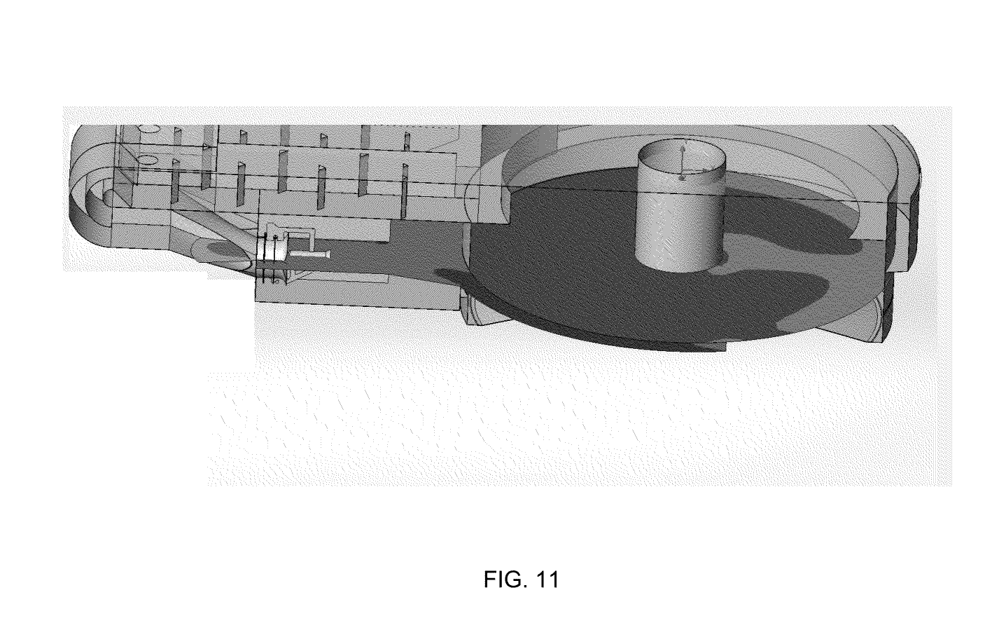

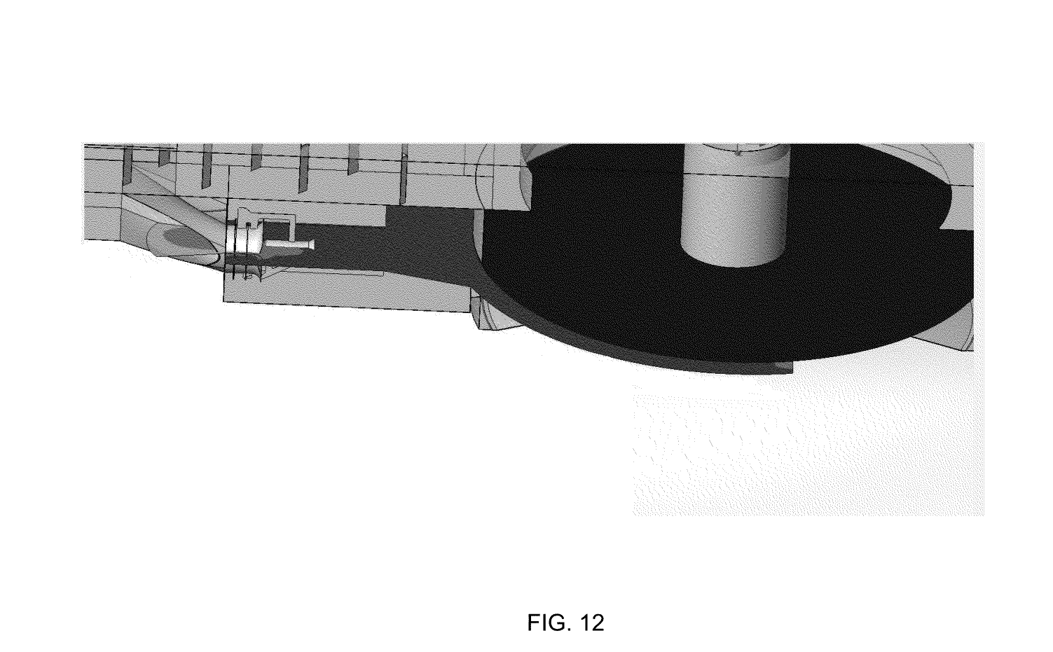

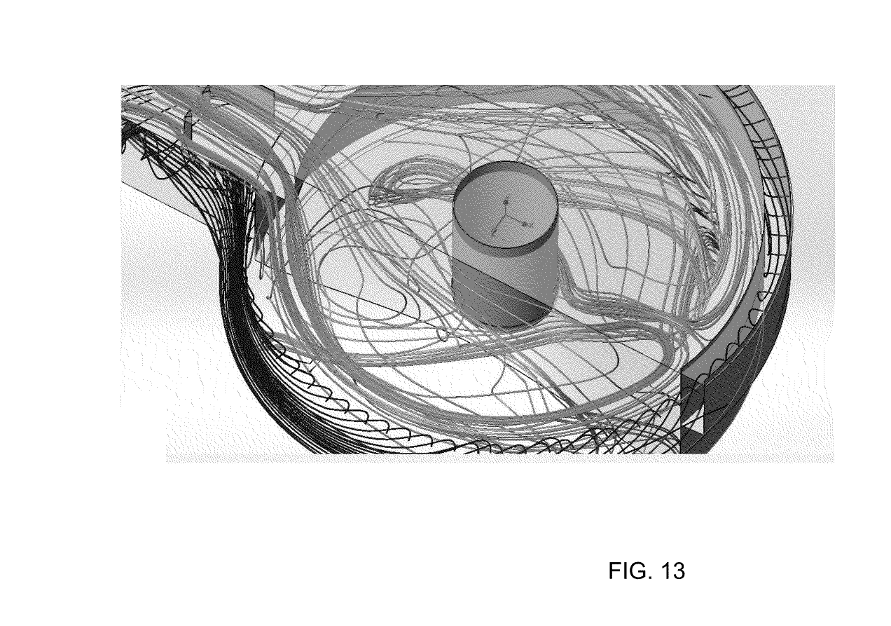

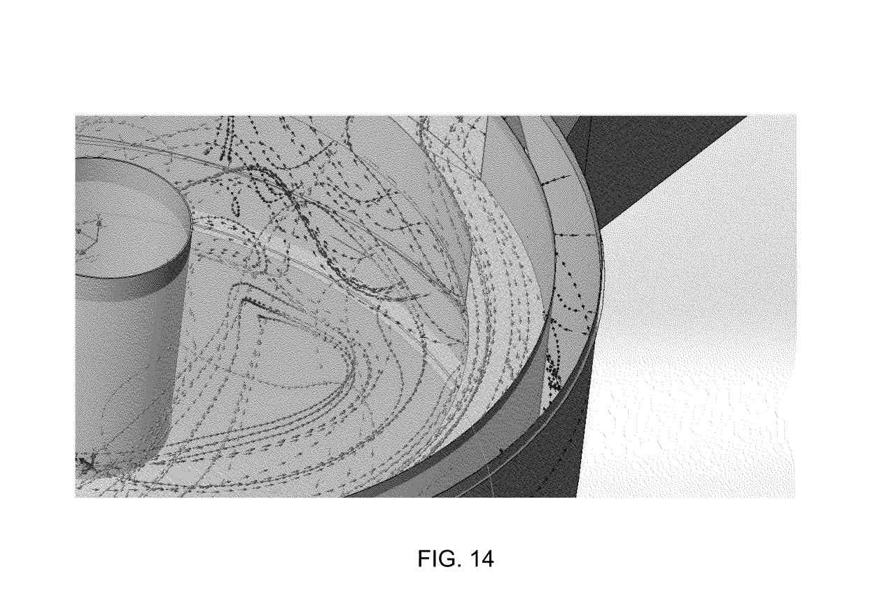

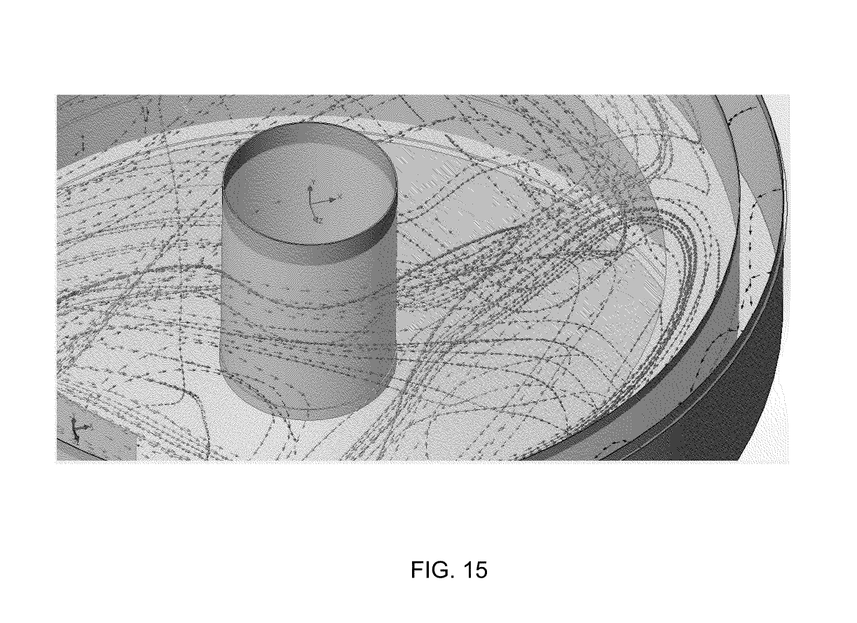

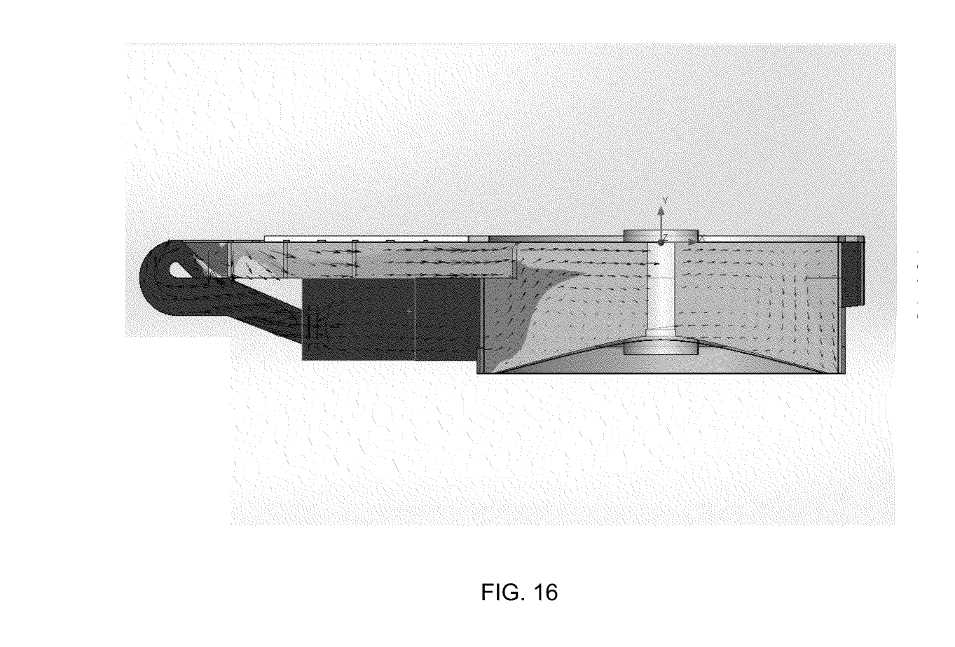

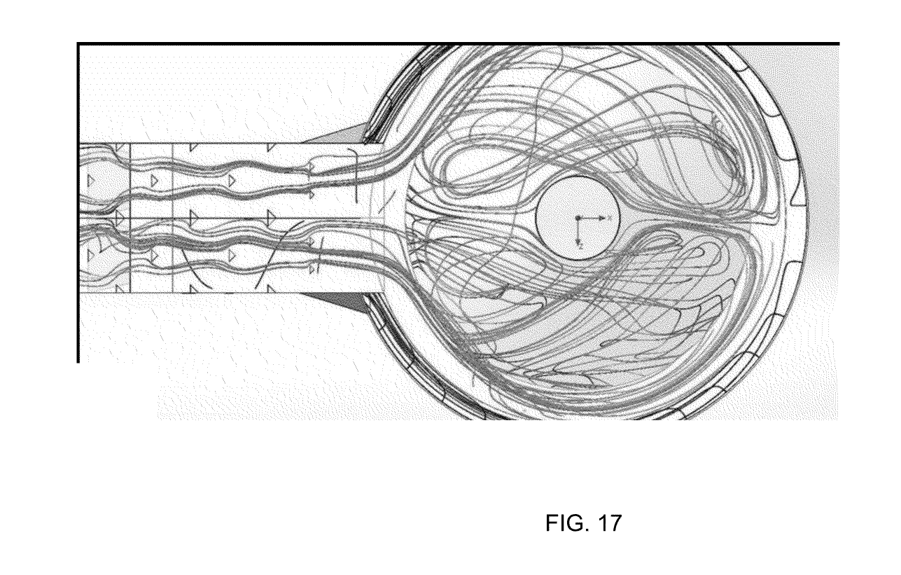

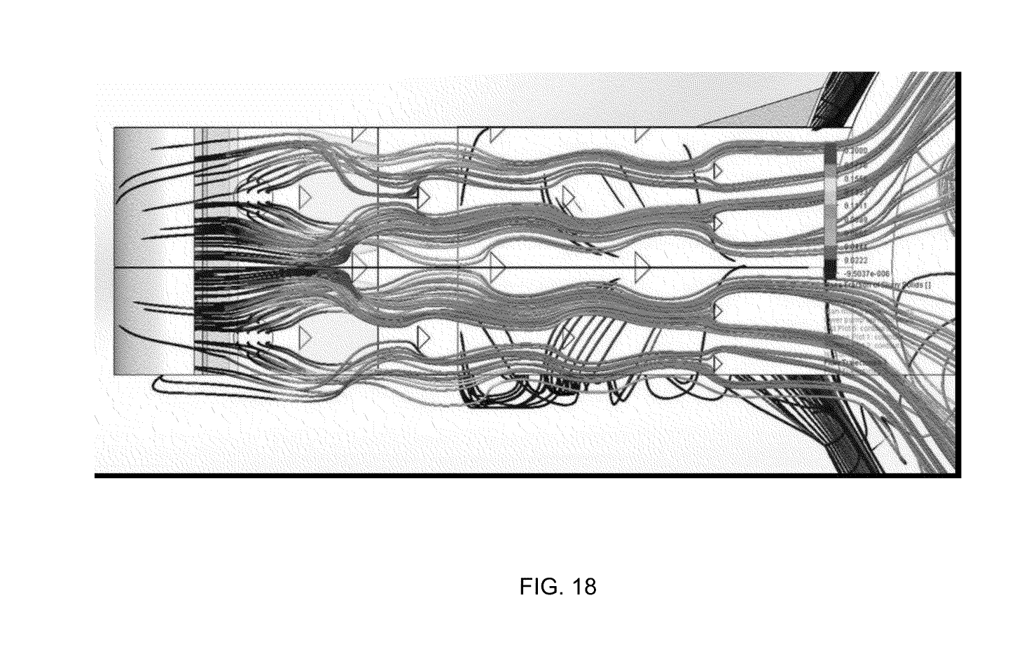

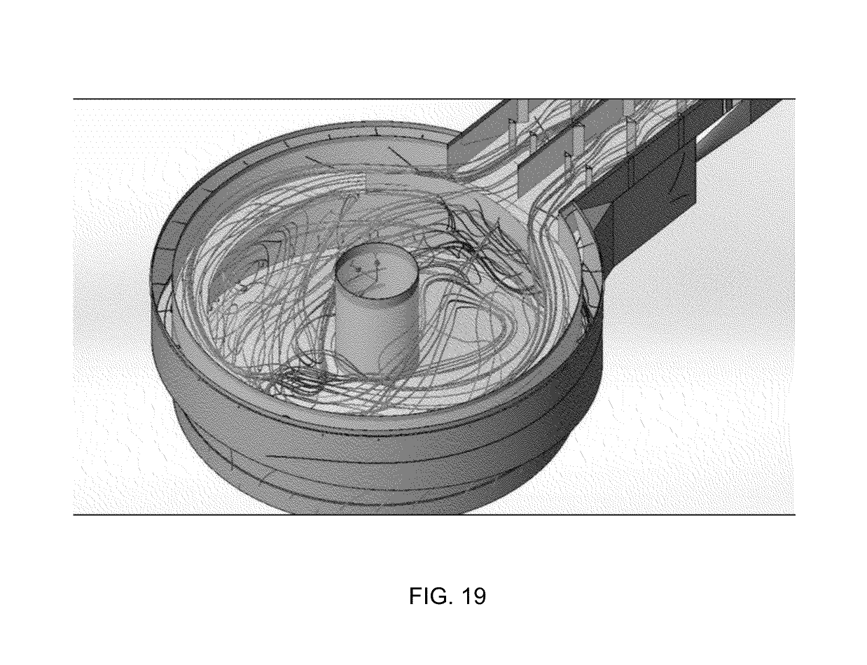

FIG. 2, at 120, shows that, in some embodiments, the mixture of feed slurry and dilution water (e.g., the diluted material) passes from the mixing zone 40 to the flocculation zone 45. In this regard, the flocculation zone can have any suitable component or characteristic that allows it to flocculate the diluted material. Indeed, in some implementations, the flocculation zone has one or more flocculant input lines 65 (as shown in FIG. 3). Moreover, in some embodiments, the flocculation zone utilizes energy generated from the flow of the diluted materials and strategically placed static mixers 60 to help perform the flocculation/mixing task. Additionally, in some embodiments, the flocculation zone is configured to provide a specific, and/or a range of specific, flocculation zone residence times, total mixing energy input, and/or proper feed solids concentration for each material and/or application that is used with the feedwell device 10.

After passing from the flocculation zone 45, FIG. 2 (at 125) shows that, in some embodiments, the mixture of feed slurry, dilution water, and flocculant is introduced into the feedwell 15. While in some embodiments, the fluids flow directly from the flocculation zone into the feedwell, FIG. 1 shows that, in some embodiments, the feedwell 15 comprises one or more baffles 70 that are sized, shaped, and/or located in a position that allows them to de-energize and/or redirect the incoming diluted, flocculated feed stream upon entry into a center portion 75 of the feedwell for a desired distribution and flow pattern and for rapid settling of solids from clear fluid (as shown at 130 and 135 in FIG. 2, respectively).

In addition to the aforementioned characteristics, the described feedwell device 10 can have several beneficial features. Indeed, in some embodiments, the described feedwell device (over some competing devices): significantly improves the flocculation and settling characteristics of solids contained in the fluids that flow through the feedwell, increases underflow densities, improves underflow viscosity characteristics, improves overflow (supernatant) characteristics, and/or decreases flocculant consumption. In sum, the described feedwell device promotes efficient separation of solids contained in liquids.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation, and use may be made without departing from the principles and concepts set forth herein. Also, as used herein, the examples, implementations, and embodiments, in all respects, are meant to be illustrative only and should not be construed to be limiting in any manner. In addition, as the terms on, disposed on, attached to, connected to, coupled to, etc. are used herein, one object (e.g., a material, element, structure, member, etc.) can be on, disposed on, attached to, connected to, or coupled to another object—regardless of whether the one object is directly on, attached, connected, or coupled to the other object, or whether there are one or more intervening objects between the one object and the other object. Also, directions (e.g., on top of, below, above, top, bottom, side, up, down, under, over, upper, lower, lateral, medial, vertical, horizontal, distal, proximal, etc.), if provided, are relative and provided solely by way of example and for ease of illustration and discussion and not by way of limitation. Furthermore, where reference is made herein to a list of elements (e.g., elements a, b, c), such reference is intended to include any one of the listed elements by itself, any combination of less than all of the listed elements, and/or a combination of all of the listed elements. Also, as used herein, the terms a, an, and one may each be interchangeable with the terms at least one and one or more. It should also be noted, that while the term step is used herein, that term may be used to simply draw attention to different portions of the described methods and is not meant to delineate a starting point or a stopping point for any portion of the methods, or to be limiting in any other way.

What is claimed is:

1. A feedwell device, comprising:
a feedwell comprising a center portion;
a launder disposed around a portion of the feedwell;
a weir disposed around a portion of the launder; and
a mixing zone,
wherein the weir is configured to allow supernatant from a thickener to flow into the launder,
wherein the launder is configured to direct the supernatant to the mixing zone, and
wherein the mixing zone is configured to mix the supernatant with a feed slurry prior to introducing a mixture of the supernatant and the feed slurry into the center portion of the feedwell.

2. The feedwell of claim 1, wherein the mixing zone comprises at least one static mixer.

3. The feedwell of claim 1 further comprising a flocculation zone that is configured to add flocculant to the mixture.

4. The feedwell of claim 1, further comprising a baffle that is configured to redirect the mixture passing from the mixing zone towards the center portion of the feedwell.

5. The feedwell of claim 1, wherein the launder comprises a sloped portion that is configured to help direct the supernatant to the mixing zone.

6. The feedwell of claim 1, further comprising a pump that is configured to pump the supernatant into the mixing zone.

7. The feedwell of claim 1, further comprising a conduit to direct feed slurry into the mixing zone.

8. The feedwell of claim 1, wherein the mixing zone comprises a static mixer.

9. The feedwell of claim 1, wherein the weir comprises an opening that is configured to disposed below a supernatant level of the thickener to allow the supernatant to flow into the launder from the thickener.

10. The feedwell of claim 6, wherein the pump comprises a low head/high volume pump.

11. A feedwell device, comprising:
a feedwell comprising a center portion;
a launder disposed around a portion of the feedwell;
a weir disposed around a portion of the launder; and
a mixing zone comprising a plurality of static mixers; and
flocculation zone,
wherein the weir is configured to allow supernatant from a thickener to flow into the launder,
wherein the launder is configured to direct the supernatant to the mixing zone,
wherein the mixing zone is configured to mix the supernatant with a feed slurry prior to introducing a mixture of the supernatant and the feed slurry into the center portion of the feedwell, and
wherein the flocculation zone is configured to add a flocculant to the mixture prior to introducing the mixture into the center portion of the feedwell.
